(19) United States
(12) Patent Application Publication
(10) Pub. No.: US 2007/0148296 A1
(43) Pub. Date: Jun. 28, 2007

(54) Frozen food item holder

(76) Inventors: Mecinna Price, South Bend, IN (US); Jared Price, South Bend, IN (US)

Correspondence Address: SACHNOFF & WEAVER, LTD., 10 SOUTH WACKER DRIVE, CHICAGO, IL, 60606-7507, US

(21) Appl. No.: 11/315,997

(22) Filed: Dec. 22, 2005

(51) Int. Cl. A22C 13/00

(52) U.S. Cl. 426/420

(57) ABSTRACT

The present invention relates to a holder for frozen food items and confections. The holder includes a grippable shaft having a first receptacle at a first or superior end of the shaft and in an embodiment, a second receptacle at a second or inferior end of the shaft. The first receptacle is adapted to receive a cone, such as those served with ice cream, or other frozen confection. The second receptacle is adapted to receive a stick, such as those served with frozen ice confections and ice cream bars. The receptacles are further adapted to receive drippage from melting frozen food items and confections. Furthermore, the holder is invertible to conveniently use either the first or second receptacle for receiving frozen food items supported in a cone, or on a stick. The receptacle not in use may be used as a support member to place the holder on a table or similar flat surface, if desired.

### FIELD OF THE INVENTION

A grippable food item holder for frozen food items or frozen confections, having a cup-like receptacle or receptacles for receiving drippage from melting frozen food items.

### BACKGROUND

Typically, when a frozen food item is being consumed, such as ice cream, frozen yogurt, snow cones and/or frozen confection foods, the food item melts, creating drippage. Sometimes, frozen food items are consumed while in a bowl, in which case the drippage may be readily managed. More frequently, however, these frozen food items, or frozen confections are consumed while lodged atop an edible cone, or held on a stick, wherein the drippage becomes difficult to manage during consumption. Both children and adults alike are noted as having drippage land on their clothing, skin and the like, creating a nuisance for the consumer.

Attempts to manage the drippage of melting frozen food items have been made in the prior art. A drip catching plate is disclosed in U.S. Pat. No. 2,321,519, providing a plate for receiving an ice cream cone. This invention is not a free-standing invention which creates inconvenience to a consumer by not providing the option to temporarily place the item on a table if necessary. Additionally, the drip catching plate is not grippable by a user.

U.S. Pat. No. 2,162,224, discloses a receptacle for an ice cream cone having a second receptacle within. The ice cream cone is manually elevated by a cord. The cord may be cumbersome and difficult to operate, and again this invention does not allow a consumer to rest the item on a table if necessary, or include a holder for a cone, and a separate holder for a stick. Also, the cost of manufacturing this receptacle may be prohibitive.

U.S. Pat. No. 5,224,646 discloses a dripless ice cream holder in FIGS. 6 and 7 including a holder for an ice cream cone including apertures in a drip plate allowing melted ice cream to drip to the bottom of the holder, in combination with a pleated internal disk that expands to the shape of the cone, and holds the cone. The present invention provides structure that holds food drippings in a cup-like receptacle, and prevents melted ice cream from dripping into the grippable portion of the holder. Additionally, the present invention does not use a pleated disk to hold the ice cream cone, and is thus less expensive to produce.

U.S. Pat. No. 6,202,970 discloses a dripping object holder having a hollow midpoint stem. Separable object support structures snap into, and out of, the hollow stem portion for holding objects to be consumed or to be held. Compared to the present invention, the device of the '970 patent would be significantly more expensive to manufacture, requires assembly prior to use, and the chance for parts to be lost by younger users is substantial.

The present invention and disclosure overcome the aforementioned disadvantages of the prior art.

### SUMMARY

The present invention relates to a hand held frozen food item holder. Particularly, an embodiment of the present invention relates to a frozen food item holder having a receptacle or receptacles for receiving drippage from a melting frozen food supported by the holder. More particularly, the present invention relates to a holder adapted to receive an ice cream cone, the holder having a receptacle for receiving drippage from a melting ice cream. In another embodiment, the holder has a second receptacle which is adapted to receive and support a frozen food item on a stick, which second receptacle is also adapted to receive drippage from melting stick mounted frozen food. In all embodiments, the food item is received in and supported by the holder and when the food is being consumed by the consumer, the holder catches the drippage from the melting food item.

In a disposable embodiment of the present invention, a grippable shaft with an aperture leading into a chamber inside the shaft, and a cup-like receptacle at one end of the shaft, is adapted to receive a frozen food item served in a cone. The bottom end of the shaft is flat, or possibly flared outward. The cup-like receptacle is adapted to catch the drippage of the frozen food item as it melts during consumption. The disposable embodiment is made of low cost plastic or cardboard material, or other suitable material as is known in the art.

In another embodiment, a grippable shaft has an aperture leading to a chamber within the shaft and a cup-like receptacle at a first or superior end for receiving a frozen food item served on a cone. A second, or inferior end of the shaft has an elongated shaped aperture and a cup-like receptacle for receiving a frozen food item supported on a stick. If either end of the shaft is in use, the opposing end may be used as a supporting member for the holder to be placed on a table or other flat surface, if desired.

Other features and advantages of the invention will be set forth in the description which follows and the accompanying drawings, wherein the embodiments of the disclosure are described and shown, and will become apparent upon examination of the following detailed description taken in conjunction with the accompanying drawings.

### BRIEF DESCRIPTION OF THE DRAWING

The above mentioned and other features of the present invention and the manner of obtaining them will become more apparent and the invention will be best understood by reference to the following description of embodiments of the invention taken in conjunction with the accompanying drawings in which:

FIG. 1 is an elevation section view of an embodiment of a disposable or non-disposable frozen food item holder with a cup-like receptacle;

FIG. 2 is a top plan view of the frozen food item holder taken along line 2-2 of FIG. 1;

FIG. 3. is a side elevation cross-section view of an embodiment of a frozen food item holder having a cup-like receptacle at both first and second ends of a grippable shaft;

FIG. 4. is a bottom plan view of the cup-like receptacle at the second end of the shaft taken along line 4-4 of FIG. 3;

FIG. 5. is a side elevation cross-section view of a frozen food item holder in a modified embodiment to that shown in FIG. 3, and having a cup-like receptacle at both ends of a grippable shaft; and

FIG. 6. is a top plan view of the cup-like receptacle at the superior end of the shaft of the embodiment of FIG. 5, taken along line 6-6 of FIG. 5.

### DESCRIPTION

While the present disclosure will be described fully hereinafter with reference to the accompanying drawings, in which a particular embodiment is shown, it is to be understood at the outset that persons skilled in the art may modify the disclosure herein described while still achieving the desired result. Accordingly, the description that follows is to be understood as a broad informative disclosure directed to persons skilled in the appropriate art and not as a limitation on the present disclosure.

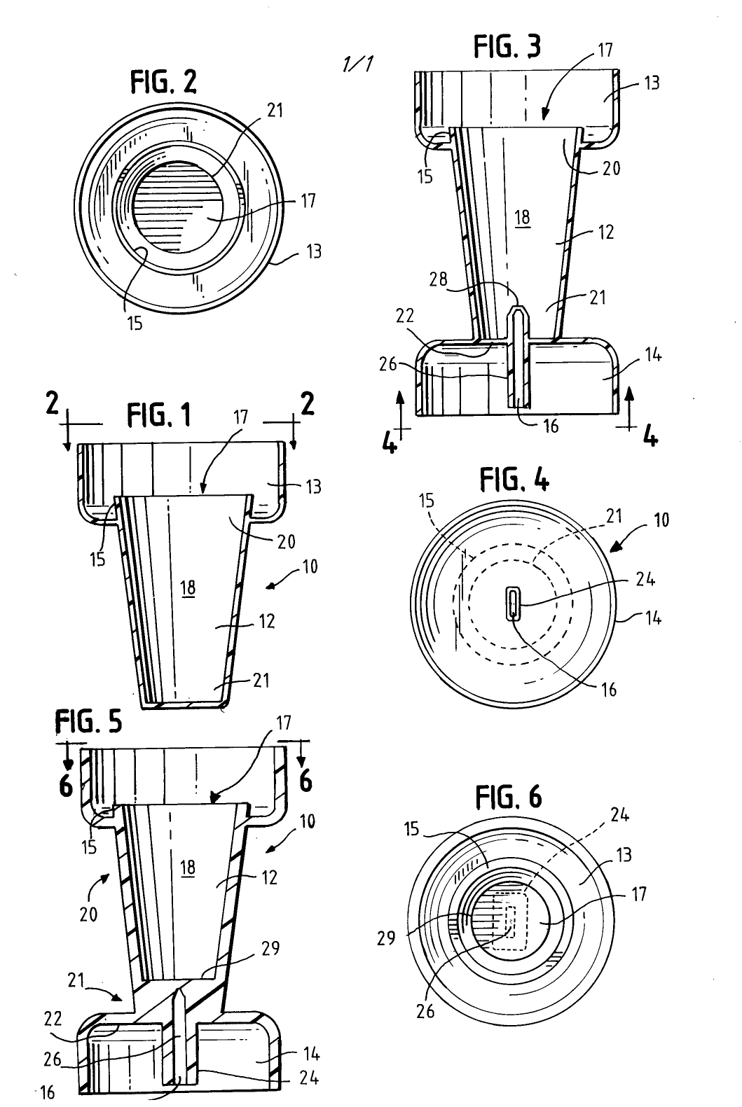

The present invention relates to a frozen food item holder, generally identified as holder 10 in the related figures. As seen in FIG. 1, FIG. 3 and FIG. 5, each holder 10 comprises a grippable shaft 12 intended to be gripped by a consumer in a vertical orientation. FIG. 1 illustrates a disposable or non-disposable embodiment of the present invention, wherein shaft 12 has a first or superior end 20 and a second or inferior end 21.

Shaft 12 also includes an aperture 17 as seen in FIGS. 1 and 2 for receiving a frozen food item in a cone. The aperture 17 leads to a chamber 18 formed in the shaft 12. The chamber 18 may be elongated within the shaft 12 and may be of varying shapes and dimensions in perimeter and depth. The elongated chamber may or may not be tapered within the shaft 12. The chamber 18 is closed at the second end 21, as seen in FIG. 1.

The shaft 12 may be generally round in shape for ease of gripping by a consumer, although those skilled in the art will recognize that the shape of the shaft 12 may be oval, square, rectangular, triangular or any other polygonal shape, as desired. The length, height, width and perimeter of the shaft 12 may be of varying dimensions. In an embodiment, the shaft 12 may be up to 5 inches in height with a perimeter of up to 3 inches. A variety of dimensions are suitable for consumers of different sizes, for instance lesser dimensions for children and larger dimensions for adults. Advertising material may also be displayed on the external face of shaft 12.

The shaft 12 may be tapered towards the second end 21, as illustrated in FIG. 1, FIG. 3 and FIG. 5. The shaft 12 may also be tapered toward the first end 20. They shaft may also be cylindrical. The shaft 12 may also have an overlaying sleeve for cushioning and comfort while gripping. The sleeve may be made of any comfortable material, examples may include but are not limited to rubbers, plastics, cardboard or paperboard.

The chamber 18 may remain empty, or may be have a filler of any suitable material known in the art. Examples of the material include, but are not limited to absorbent paper or fiber material, or the like.

Referring to FIG. 1, the first or superior end 20 of shaft 12 comprises a first cup-like receptacle 13 that is open at the top. The receptacle 13 may be continuously molded with the shaft 12, or may be a separate piece adapted to be adjoined to the shaft 12 by appropriate means known in the art. In an embodiment, the receptacle 13 is generally round, although those skilled in the art will recognize that receptacle 13 may be of any shape including but not limited to oval, square, rectangular, triangular or any other polygonal shape. The receptacle 13 includes an aperture 17 generally at the middle of the bottom of the receptacle 13. The intersection where the receptacle 13 joins shaft 12 forms a ledge 15 for supporting a cone inserted into aperture 17 by a user, as will be explained. Those skilled in the art will recognized that he dimensions of the receptacle 13 may vary in height, width and depth. The dimensions of the aperture 17 may also vary.

In an embodiment, the aperture 17 is appropriately dimensioned to receive a cone, flat bottomed or pointed bottom, that are typical of those on which ice cream is served. The receptacle 13 catches the drippage of a melting frozen food item when being consumed by a consumer and the cone is placed in aperture 17.

A second embodiment of the present invention is illustrated in FIGS. 3 and 4, where the shaft 12 comprises a cup-like second receptacle 14 at the second or inferior end 21 of the shaft. The second receptacle 14 is generally cup shaped, as is receptacle 13. Second receptacle 14 has a centrally located aperture 16, and aperture 16 is generally elongated in cross section, as seen in FIG. 4. In an embodiment, aperture 16 is configured suitable for receiving a stick, typical of those on which frozen confections and ice cream bars are supported and served.

The embodiment of holder 10 shown in FIG. 3 includes a bottom portion 22, with a right angle molded tubular portion 24 formed as part of the bottom portion 22. The aperture 16 opens into a slot 26 formed internally of tubular portion 24. Slot 26 is dimensioned in cross-section and length to receive and hold a stick upon which an ice cream or confection bar is mounted. In the embodiment shown in FIG. 3, the tubular portion 24 is formed of relatively thin material, substantially the same thickness as the remainder of the material comprising holder 10. The lower portion 28 of tubular portion 24 is closed to provide support for a stick inserted through aperture 16, and extends below the bottom portion 22 and a short distance into chamber 18.

The embodiment of the invention disclosed in FIGS. 5 and 6 is similar to the embodiment shown in FIGS. 3 and 4, with the exception that a thicker material is utilized in the construction of the holder 10, and additional support is provided for tubular portion 24. In this embodiment, the bottom portion 22 of second receptacle 14 comprises a built up mass of material 28 into which the lower portion 28 of tubular portion 24 extends. The mass of material 29, as seen in FIG. 5, extends to the outer sidewalls forming chamber 18.

In use, the holder 10 illustrated in FIG. 1 is adapted to be a disposable or non-disposable embodiment of the present invention, and can be used to hold ice cream cones of varying shapes. The cone, not shown, is inserted through aperture 17 until the cone abuts against ledge 15, and the bottom of the cone extends into chamber 18. As the ice cream, or other frozen confection, supported by the cone begins to melt, the drippings are caught and held in receptacle 13 and away from the hand of the user. When the ice cream reaches the level of the top of the cone, the cone is removed from the holder 10.

In the embodiment illustrated in FIGS. 1 and 2, the shaft 12 is tapered inward toward the bottom end 21, and has a flat bottom that may not be conducive unilaterally to supporting the holder 10, ice cream and cone when placed unattended on a flat surface. The scope of the present invention, however, includes embodiments (not shown) where the shaft 12 may be straight, or tapered outwardly at the bottom 21, or a widened bottom portion 21 of shaft 12 is provided, to allow the holder 10 with cone and ice cream or confection product in place to be self supporting on a flat surface while unattended.

As stated previously, the embodiment of holder 10 illustrated in FIGS. 1 and 2 can be disposable after each use, in which case the holder 10 is manufactured of low cost materials, such as cardboard, paperboard, relatively thin plastic, or the like. The holder 10 can also display advertising copy on the exterior of shaft 12. A non-disposable version of the embodiment illustrated in FIGS. 1 and 2 will be made of more durable material, such as a plastic coated paper, ceramic, clay or any other suitable material. This material will also be washable in hot water for reuse.

The embodiments of the holder 10 illustrated in FIGS. 3 and 4 and in FIGS. 5 and 6, is adapted to hold a cone for ice cream or other frozen confection inserted into aperture 17 and held against ledge 15 in the same manner as described above with reference to FIG. 1. The drippings from the melting confection will be caught in receptacle 13, also as previously described. The holder 10 in the embodiment of FIGS. 3 and 4 also includes second receptacle 14 and tubular portion 24. In the alternate use of this embodiment, the holder 10 is inverted such that second receptacle 14 and tubular portion 26 are facing upward. A stick, on which an ice cream or frozen confection food product is supported, is inserted into aperture 16 such that the stick is lodged loosely or tightly in tubular portion 24. The elongated configuration holds the food product in place while the user grips shaft 12 with one hand. The melting food product drips into and is caught by second receptacle 14.

In the embodiment of FIGS. 3 and 4, each of the receptacles 13 and 14 are of sufficient diameter to provide a supporting base for the holder 10 when the holder is placed on a flat surface. Thus, either an ice cream cone or an ice cream bar on a stick, for example, could be placed on a flat surface and left unattended without toppling over. Also, while left unattended, the drippings from the melting food product will be caught by either receptacle 13 or 14, and not drip onto the flat surface, thereby preventing any mess.

The use of the embodiment of the invention described above with reference to the embodiment of FIGS. 3 and 4 is likewise applicable to the embodiment illustrated in FIGS. 5 and 6.

If desired, the holder 10 of any of the embodiments described herein may be manufactured by plastic injection molding to provide a holder of a variety of colors or color combinations, or provide a translucent holder if desired.

Various features of the described invention have been shown and described in connection with the illustrated embodiments. However, it is to be understood that these features are presented herein as being illustrative of the subject invention, and that the scope of the invention is to be determined by the appended claims.

We claim:

1. A holder for a meltable food product supported in a cone comprising:
a grippable shaft forming a hollow body of the holder;
a cup-like receptacle mounted on the shaft, the cup-like receptacle having side walls extending away from the grippable shaft, and an aperture opening into the hollow body, the cup-like receptacle having a ledge formed by the intersection of the cup-like receptacle and the shaft; and
the ledge adapted to support the cone when the cone is inserted through the aperture.

2. The holder of claim 1 wherein the shaft has a flat bottom adapted to support the shaft and cup-like receptacle when the shaft is placed on a flat surface.

3. The holder of claim 1 wherein the cup-like receptacle has a greater crosswise dimension than a largest crosswise dimension of the shaft.

4. The holder of claim 1 wherein the aperture is circular in perimeter.

5. A holder for a meltable food product supported on a cone or a stick, comprising:
a grippable shaft forming a hollow body of the holder;
a first cup-like receptacle mounted on a first end of the shaft, the first cup-like receptacle having side walls extending away from the grippable shaft and a first aperture opening into the hollow body;
a second cup-like receptacle mounted on a second end of the shaft, the second cup-like receptacle having side walls extending away from the grippable shaft;
a bottom portion of the second cup-like receptacle, said bottom portion extending across said second end of said grippable shaft;
a tubular portion connected to and extending away from said bottom portion, said tubular portion having an axial dimension greater than a radial dimension;
a second aperture in said tubular portion, said second aperture providing an opening into said tubular portion;
said tubular portion adapted to receive and hold a stick inserted through said second aperture, said stick supporting said meltable food product.

6. The holder of claim 5 wherein the second aperture is elongated in cross section.

7. The holder of claim 5 wherein an end of said tubular portion opposite said aperture is closed.

8. The holder of claim 5 wherein the first and second cup-like receptacles each have a greater crosswise dimension than a largest crosswise dimension of the shaft.

9. The holder of claim 8 wherein one of the first and second cup-like receptacles provides support for the holder when one of said first and second cup-like receptacles is placed on a flat surface.

10. The holder of claim 5 wherein said grippable shaft and said first and second cup-like receptacles and said bottom portion of said second cup-like receptacle are constructed of a material having a predetermined thickness;
said tubular portion having sidewalls of said predetermined thickness.

11. The holder of claim 5, wherein said grippable shaft and said first and second cup-like receptacles are constructed of material having a first predetermined thickness;
said bottom portion of said second cup-like receptacle being constructed of a material having a second predetermined thickness, said second predetermined thickness being greater than said first predetermined thickness.

12. The holder of claim 11, wherein said tubular portion has sidewalls of a third predetermined thickness, said third predetermined thickness being greater than said first predetermined thickness.

13. The holder of claim 11 wherein said tubular portion extends into said material having a second predetermined thickness.

14. The holder of claim 5 wherein the first aperture is circular in cross section.
